(19) United States
(12) Patent Application Publication
(10) Pub. No.: US 2009/0142029 A1
(43) Pub. Date: Jun. 4, 2009

(54) Motion transition method and system for dynamic images

(75) Inventors: I-Chen Lin, Taoyuan (TW); Jen-Yu Peng, Taoyuan (TW); Jui-Hsiang Chao, Taoyuan (TW); Yu-Jung Cheng, Taoyuan (TW)

Correspondence Address: BIRCH STEWART KOLASCH & BIRCH, PO BOX 747, FALLS CHURCH, VA, 22040-0747, US

(73) Assignee: Institute for Information Industry

(21) Appl. No.: 12/000,748

(22) Filed: Dec. 17, 2007

(30) Foreign Application Priority Data
Dec. 3, 2007 (TW) 96145893

(51) Int. Cl. G11B 27/00

(52) U.S. Cl. 386/52; 386/E05.001

(57) ABSTRACT

A motion transition method for dynamic images is disclosed. Pre-recorded motion transition data is clustered to generate a graphic structure. Path information for the graphic structure is obtained using a path search operation. Required motion transition data for two motion clips is retrieved based on the path information and is adjusted. Motion clips are merged using real motion data, thus increasing motion variations, enhancing interactions, and reducing labor intensive production and unnatural images.

### BACKGROUND OF THE INVENTION

1. Field of the Invention

The invention relates to data processing, and more particularly to a motion transition method and system for dynamic images.

2. Description of the Related Art

With respect to computer animation and games, performer motions are directly extracted using motion capture for more realistic rule motions. Directly applying the motion capture, however, to an interaction system (a role-playing game), requires recording a large amount of motions with different angles and reactions, representing dynamic effects, only by the extracted motions.

Motion blending and motion transition can be used to expand motion variability. Motion blending generates a new motion by processing multiple animation clips using interpolation and different multiplied weightings, enriching the motion variability. The motion transition merges different motion clips and adds an image buffer to smooth the section between the merging motion clips using the interpolation.

With respect to the data transition, as shown in FIG. 1, motion clip A and motion clip B are merged using motion clip C with real-time generation, smoothing data transition from motion clip A to motion clip B. As described, the motion transition directly generates motion transition data (values for joint rotations of roles) between the two motion clips using a mathematical algorithm (interpolation, for example), such that unnatural display may be generated and the generated motion transition data has no variability.

Thus, an improved motion transition method and system for dynamic images is desirable.

### BRIEF SUMMARY OF THE INVENTION

Motion transition methods for dynamic images are provided. An exemplary embodiment of a motion transition method for dynamic images comprises the following. At least one motion transition data comprising plural image frames is pre-recorded. The image frames are clustered to generate a graphic structure comprising plural motion clusters. A motion cluster is determined, residing in the graphic structure, that provides at least one second motion clip merging a first motion clip and a third motion clip. A path search operation is performed to determine whether at least one motion path corresponding to the second motion clip is located in the graphic structure. If a motion path is located, at least one second motion clip from plural motion clusters along the motion is respectively selected, to retrieve plural second motion clips as motion transition data. The second motion clips are adjusted and the first motion clip and the third motion clip are merged using the second motion clips.

Motion transition systems for dynamic images are provided. An exemplary embodiment of a motion transition system for dynamic images comprises a database, a data cluster and graphic module, a determination module, and a motion adjustment and mergence module. The database stores at least one pre-recorded motion transition data comprising plural image frames. The data cluster and graphic module clusters the image frames to generate a graphic structure comprising plural motion clusters. The determination module determines a motion cluster, residing in the graphic structure, that provides at least one second motion clip merging a first motion clip and a third motion clip, and performs a path search operation to determine whether at least one motion path corresponding to the second motion clip is located in the graphic structure. If a motion path is located, the motion adjustment and mergence module respectively selects at least one second motion clip from plural motion clusters along the motion path to retrieve plural second motion clips as motion transition data, and adjusts the second motion clips and merges the first motion clip and the third motion clip using the second motion clips.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of conventional data transition;

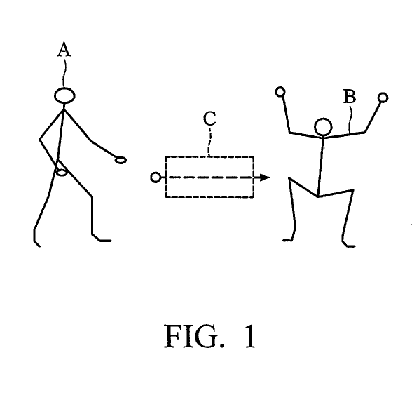

FIG. 2 is a schematic view of an embodiment of implementing clustering and graphic structures to image frames of the present invention;

FIG. 3 is a flowchart of a motion transition method for dynamic images of the present invention;

FIG. 4 is a schematic view of clustering image frames of the present invention;

FIG. 5 is a schematic view of calculating similarities of motion postures of the present invention;

FIG. 6 is a schematic view of implementing graphic structure to image frames of the present invention;

FIG. 7 is a schematic view of determining motion clusters for a graphic structure to which motion data to be merged belongs of the present invention;

FIG. 8 is a schematic view of a motion path search of the present invention;

FIG. 9 is a schematic view of selecting appropriate motion clips for image frame mergence of the present invention;

FIG. 10 is a schematic view of mixing motion clips of the present invention; and

FIG. 11 is a schematic view of a motion transition system for dynamic images of the present invention.

### DETAILED DESCRIPTION OF THE INVENTION

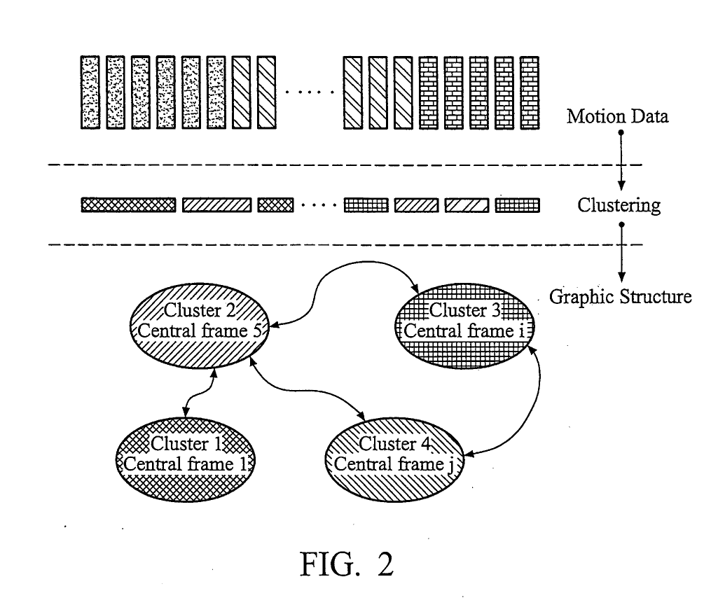

Several exemplary embodiments of the invention are described with reference to FIGS. 2 through 11, which generally relate to motion transition for dynamic images. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a motion transition method and system for dynamic images.

An embodiment of the motion transition method and system clusters pre-recorded motion transition data to generate a graphic structure, obtains applicable path information using a path search mechanism, retrieves selected data transition data for two motion clips from the path information, and adjusts details of the selected data transition data. Motion clips are merged using real motion data, increasing motion variations, enhancing interactions, and reducing labor intensive production and unnatural images.

The invention generates motion transition data using pre-recorded motion data. Clustering and graphic structures are implemented to the pre-recorded motion data and applicable motion transition data is generated using a path search operation to smooth the merging section between two motion clips. Using pre-recorded real motion data to generate the motion transition data can overcome unnatural displays and achieve motion variability. As shown in FIG. 2, plural image frames (P₁, P₂, . . . , Pₙ) for motion postures are compared with each other and image frames with similar motion postures are clustered to the same image clip for following structural processing.

It is noted that “motion posture” indicates a human motion posture in an image frame. Thus, describing a motion posture refers to describing an image frame corresponding to the motion posture, and will not be further explained in the following.

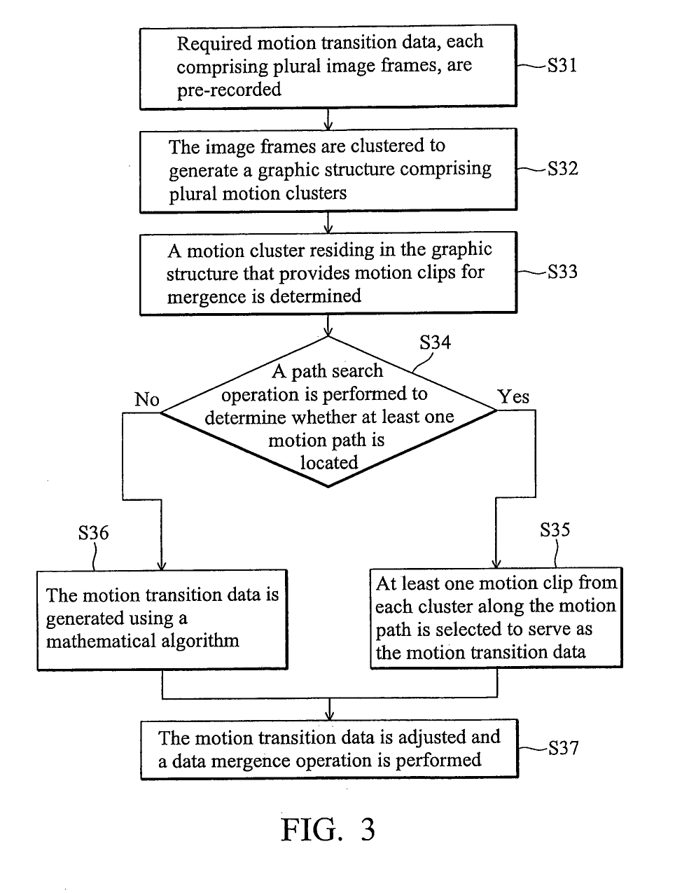

FIG. 3 is a flowchart of a motion transition method for dynamic images of the present invention.

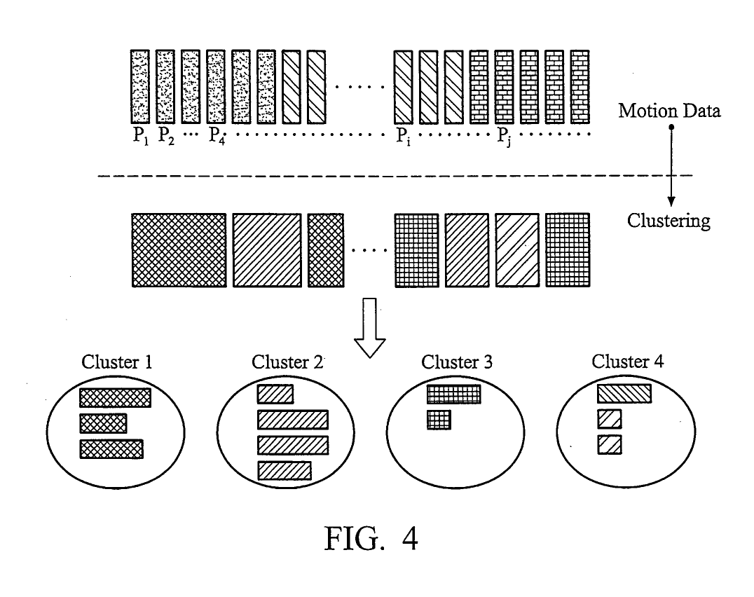

Required motion transition data, each comprising plural image frames, are pre-recorded (step S31). The image frames are clustered to generate a graphic structure comprising plural motion clusters (step S32). When motion data clustering is implemented, similarities of role postures in the image frames should first determined. Referring to FIG. 4, a motion posture of a first image frame (P₁, for example) serves as a central motion posture (a central image frame) of a first motion cluster (cluster 1, for example), and the difference between the central motion posture and a motion posture of another image frame (P₂, for example) is determined using a similarity calculation method. If the difference is less than a predetermined threshold value, the image frame of P₂ is merged into cluster 1. If the difference is greater than that of the predetermined threshold value, a new motion cluster (cluster 2, for example) is created and the motion posture of P₂ serves as a central motion posture of cluster 2. The described process is repeated, comparing each motion posture of each image frame with each central motion posture of each cluster to be merged into the existing clusters or create a new cluster, thus completing the automatic clustering process. In this embodiment, created clusters comprise cluster 1 (C₁), cluster 2 (C₂), cluster 3 (C₃), and cluster 4 (C₄), each comprising plural motion clips, as shown in FIG. 4.

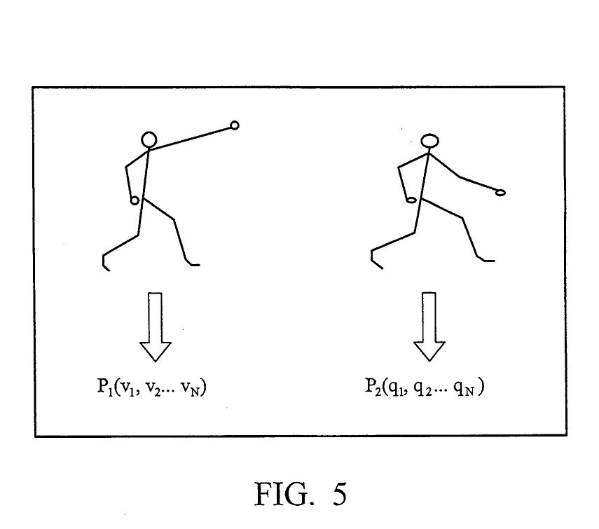

Calculating similarities of motion postures will next be described, wherein it is determined whether one motion posture is similar to another according to a distance gap in the space between each joint nodes relating to both of the motion postures. As shown in FIG. 5, P() is defined as a set of positions in the space for all joint nodes of a motion posture. Thus, P₁(v₁, v₂, . . . , vₙ) and P₂(q₁, q₂, . . . , qₙ) respectively indicate the sets of positions in the space for all joint nodes of two motion postures. The difference between both of the motion postures is defined as D=P₁−T×W×P₂, where T represents a transformation matrix aligning origins of both of the motion postures, and W represents weightings relating to each joint. The difference is compared with the predetermined threshold value to determine the similarity of both of the motion postures.

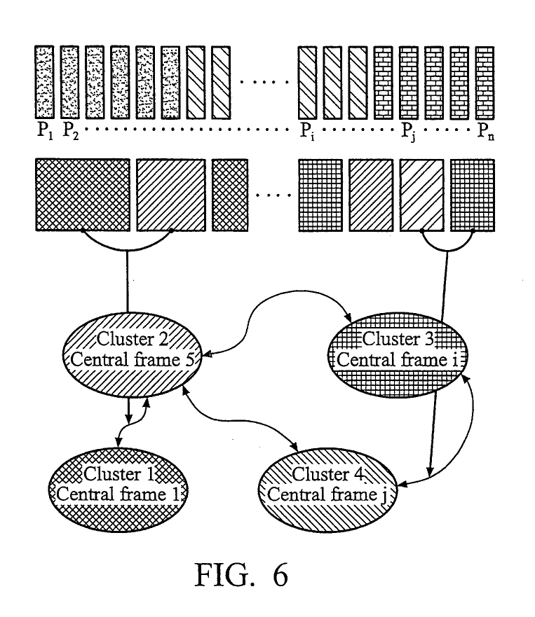

When the clustering is complete, relationships between each cluster are created to eventually create the graphic structure. Similar motion postures are classified to the same cluster, so neighboring motion postures residing in the same image data and merged to the same cluster form portions of motion clips. Referring to FIG. 6, when cluster 1 comprises motion clip a (not shown) and cluster 2 comprises motion clip b (not shown) and motion clip a is located prior to motion clip b in the motion data, a motion path directed from cluster 1 to cluster 2 is determined. The described process is repeated to complete generation of relationships between each cluster.

It is noted that, as shown in FIG. 6, the central frame (the central motion posture) of cluster 1 is the first frame of the original motion data, the central frame of cluster 2 is the fifth frame of the original motion data, the central frame of cluster 3 is the i^{th} frame of the original motion data, and the central frame of cluster 4 is the j^{th} frame of the original motion data, which is not to be limitative.

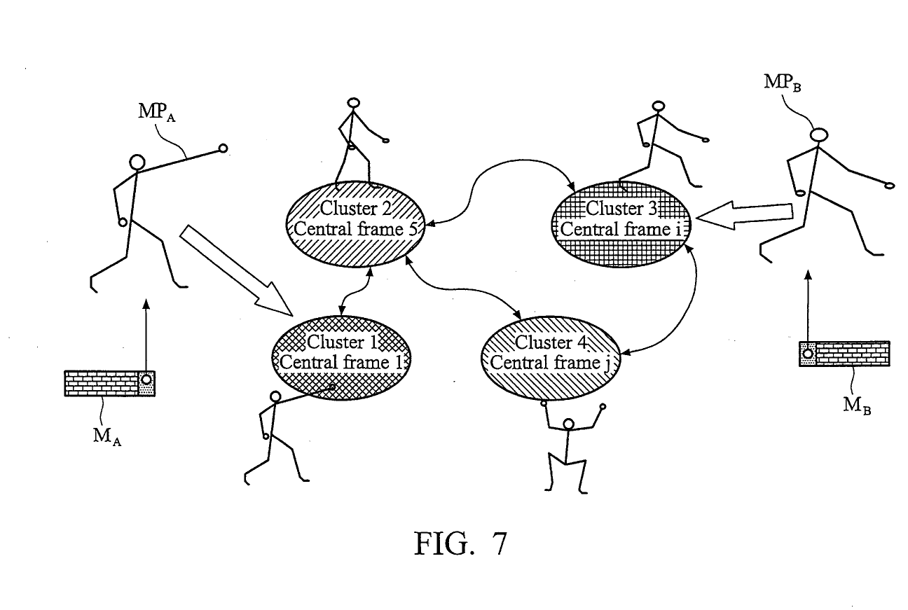

Next, a motion cluster residing in the graphic structure that provides motion clips for mergence is determined (step S33). As shown in FIG. 7, if motion clips M_{A} and M_{B} should be merged, clusters in which image frame MP_{A} connecting to motion clips M_{A} and image frame MP_{B} connecting to motion clips M_{B} reside must be located. Thus, the postures of both of the image frames are compared with motion postures of motion clips residing in different clusters to determine a motion cluster residing in the graphic structure that provides motion clips for mergence.

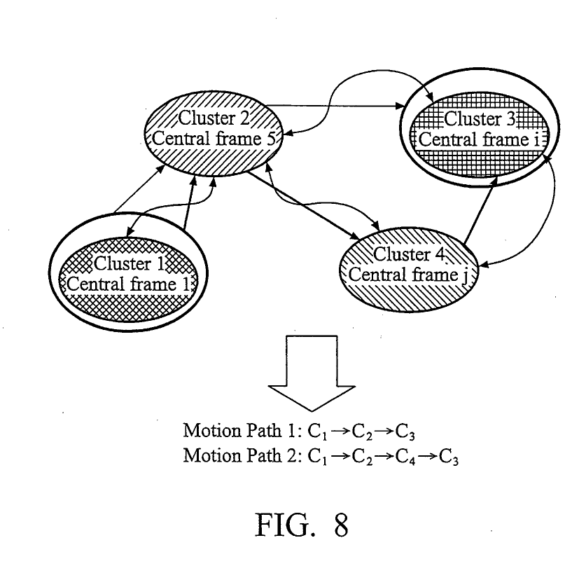

A path search operation is performed to determine whether at least one motion path is located (step S34). Different motion paths indicate different portions of motion transition data are generated based on different portions of motion data along the motion paths, providing high elasticity of motion transition. Motion paths located from each cluster indicate positions of each cluster in which motion clips merging image frames MC_{A} and MC_{B} reside. All motion paths can be located using a path search algorithm (Greedy Search, for example). As shown in FIG. 8, the beginning of the motion path resides in cluster 1 and the destination thereof resides in cluster 3, thus locating motion path 1 (C₁→C₂→C₃) and motion path 2 (C₁→C₂→C₄→C₃).

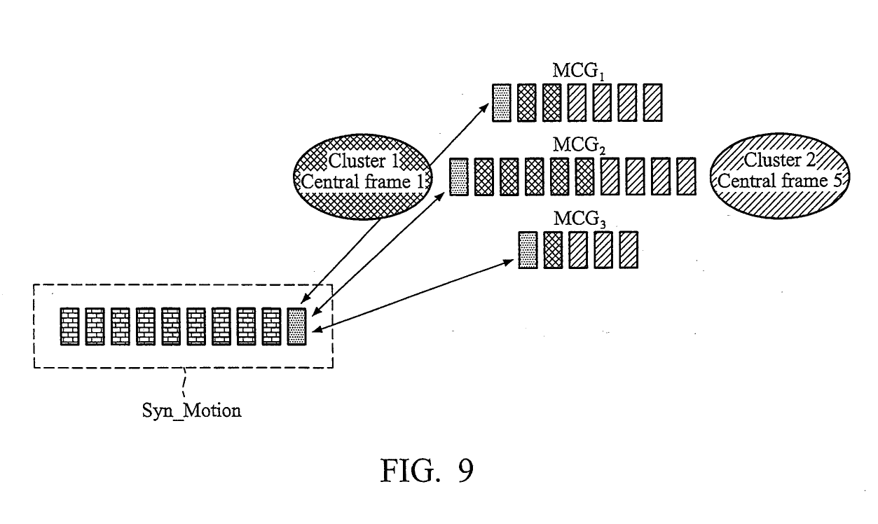

If at least one motion path is located, at least one motion clip from each cluster along the motion path is selected to serve as the motion transition data (step S35). As shown in FIG. 9, all applicable motion clips for clusters 1 and 2 can be located based on the path search operation, generating the first motion clip group (MCG₁), the second motion clip group (MCG₂), and the third motion clip group (MCG₃) based on motion posture similarities. Each motion clip group comprises plural motion clips and each motion clip comprises plural image frames. The first motion posture of the first motion clip of the first motion clip cluster is compared with the last motion posture of a synthesized motion clip to obtain differences between each of the motion postures. Based on a motion posture with the similarity corresponding to a threshold, a motion clip group with a length of the motion clips thereof corresponding to a predefined threshold value is selected, and the motion clips of the selected motion clip group serve as the motion transition data.

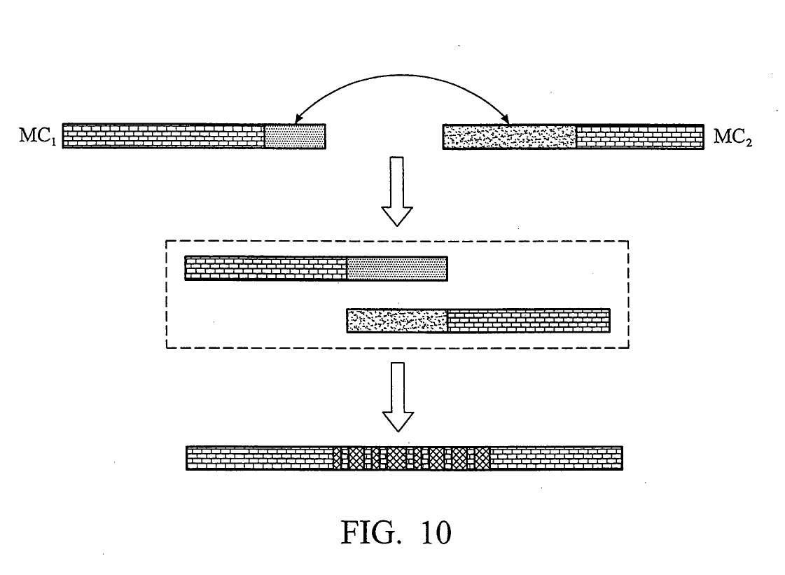

If a motion path is not located, the motion transition data is generated using a mathematical algorithm (Bezier Interpolation, for example) (step S36). When required motion transition data is obtained, the motion transition data is adjusted and a data mergence operation is performed (step S37). The selected motion clips are retrieved for merging another two motion clips, mixing the defined start portion of a motion clip with the end portion of the other. As shown in FIG. 10, a length of an image portion for mergence of each motion clip (motion clip MC₁ and MC₂, for example) is respectively defined. Both of the image portions are calculated using dynamic time wrapping to equalize the lengths thereof and relationships therebetween are recorded. The start portion and the end portion are mixed using quaternion interpolation, completing the mergence of both of the motion clips.

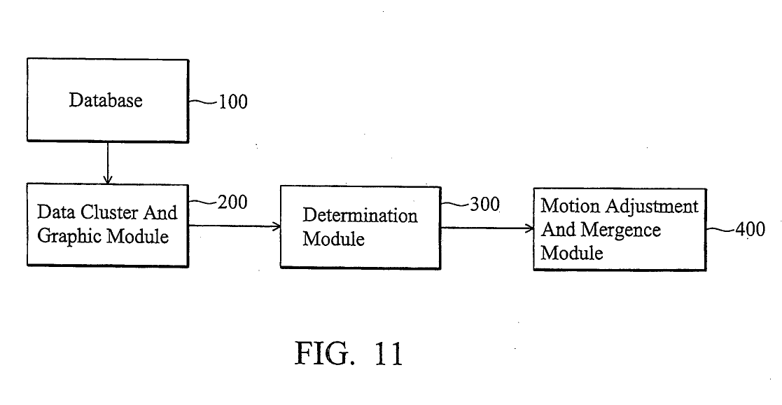

FIG. 11 is a schematic view of a motion transition system for dynamic images of the present invention.

An embodiment of a motion transition system comprises a database 100, a data cluster and graphic module 200, a determination module 300, and a motion adjustment and mergence module 400. The database 100 stores at least one pre-recorded motion transition data comprising plural image frames. The data cluster and graphic module 200 clusters the image frames to generate a graphic structure comprising plural motion clusters. The determination module 300 determines a motion cluster, residing in the graphic structure, that provides at least one second motion clip merging a first motion clip and a third motion clip, and performs a path search operation to determine whether at least one motion path corresponding to the second motion clip is located in the graphic structure. If a motion path is located, the motion adjustment and mergence module 400 respectively selects at least one second motion clip from plural motion clusters along the motion path to retrieve plural second motion clips as motion transition data, and adjusts the second motion clips and merges the first motion clip and the third motion clip using the second motion clips.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motion transition method for dynamic images, comprising:
pre-recording at least one motion transition data comprising plural image frames;
clustering the image frames to generate a graphic structure comprising plural motion clusters;
determining a motion cluster residing in the graphic structure that provides at least one second motion clip merging a first motion clip and a third motion clip;
performing a path search operation to determine whether at least one motion path corresponding to the second motion clip is located in the graphic structure;
respectively selecting at least one second motion clip from plural motion clusters along the motion path to retrieve plural second motion clips as motion transition data, if a motion path is located; and
adjusting the second motion clips and merging the first motion clip and the third motion clip using the second motion clips.

2. The motion transition method for dynamic images as claimed in claim 1, wherein the motion transition data is generated using a mathematical algorithm if the motion path is not located.

3. The motion transition method for dynamic images as claimed in claim 1, wherein the clustering step further comprises:
serving a first motion posture of a first image frame as a central motion posture of a first motion cluster;
determining the difference between a second motion posture of a second image frame and the central motion posture;
merging the second image frame into the first motion cluster if the difference is less than a predetermined threshold value; and
creating a second motion cluster if the difference is greater than that of the predetermined threshold value, and serving the second motion posture as a central motion posture of the second motion cluster.

4. The motion transition method for dynamic images as claimed in claim 3, wherein the clustering step further comprises determining the difference between the first and second motion posture according to a distance gap in the space between each joint nodes relating to the first and second motion posture.

5. The motion transition method for dynamic images as claimed in claim 3, further comprising:
generating at least one first motion clip cluster and at least one second motion clip cluster according to the similarity between the first and third motion posture, wherein each motion clip cluster comprises plural motion clips and each motion clip comprises plural image frames;
comparing the first motion posture of the first motion clip of the first motion clip cluster with the last motion posture of a synthesized motion clip to obtain differences between each of the motion postures; and
selecting satisfied motion clip clusters with the length of a motion clip corresponding to a predefined threshold value to serve motion clips of the selected motion clip clusters as the motion transition data, based on motion postures of which the differences correspond to a threshold value.

6. The motion transition method for dynamic images as claimed in claim 1, wherein the graphic structure at least comprises a first motion cluster and a second motion cluster, and the clustering step further comprises:
generating a motion path for the first motion cluster directing to the second motion cluster, when the first and second motion clips belongs to the same motion data.

7. The motion transition method for dynamic images as claimed in claim 1, wherein merging the first motion clip and the third motion clip further comprises:
respectively defining image lengths of a first image portion of the first motion clip and a second image portion of a second motion clip of the selected second motion clips;
calculating the first and second image portions using a dynamic time warping method to equalize the image portions thereof and record comparative relationships thereof; and
merging the first image portion of the first motion clip with the second image portion of the second motion clip.

8. A motion transition system for dynamic images, comprising:
a database, storing at least one pre-recorded motion transition data comprising plural image frames;
a data cluster and graphic module, clustering the image frames to generate a graphic structure comprising plural motion clusters;
a determination module, determining a motion cluster, residing in the graphic structure, that provides at least one second motion clip merging a first motion clip and a third motion clip, and performing a path search operation to determine whether at least one motion path corresponding to the second motion clip is located in the graphic structure; and
a motion adjustment and mergence module, if a motion path is located, respectively selecting at least one second motion clip from plural motion clusters along the motion path to retrieve plural second motion clips as motion transition data, and adjusting the second motion clips and merging the first motion clip and the third motion clip using the second motion clips.

9. The motion transition system for dynamic images as claimed in claim 8, wherein the motion adjustment and mergence module generates the motion transition data using a mathematical algorithm if the motion path is not located.

10. The motion transition system for dynamic images as claimed in claim 8, wherein the data cluster and graphic module serves a first motion posture of a first image frame as a central motion posture of a first motion cluster, determines the difference between a second motion posture of a second image frame and the central motion posture, merges the second image frame into the first motion cluster if the difference is less than a predetermined threshold value, and creates a second motion cluster if the difference is greater than that of the predetermined threshold value, and serving the second motion posture as a central motion posture of the second motion cluster.

11. The motion transition system for dynamic images as claimed in claim 10, wherein the data cluster and graphic module determines the difference between the first and second motion posture according to a distance gap in the space between each joint nodes relating to the first and second motion posture.

12. The motion transition system for dynamic images as claimed in claim 10, wherein the motion adjustment and mergence module generates at least one first motion clip cluster and at least one second motion clip cluster according to the similarity between the first and third motion posture, wherein each motion clip cluster comprises plural motion clips and each motion clip comprises plural image frames, compares the first motion posture of the first motion clip of the first motion clip cluster with the last motion posture of a synthesized motion clip to obtain differences between each of the motion postures, and, based on motion postures of which the differences correspond to a threshold value, selects satisfied motion clip clusters with the length of a motion clip corresponding to a predefined threshold value to serve motion clips of the selected motion clip clusters as the motion transition data.

13. The motion transition system for dynamic images as claimed in claim 8, wherein, when the first and second motion clips belongs to the same motion data but belongs a first and second motion cluster, respectively, of the graphic structure, the data cluster and graphic module generates a motion path for the first motion cluster directing to the second motion cluster.

14. The motion transition system for dynamic images as claimed in claim 8, wherein the motion adjustment and mergence module respectively defines image lengths of a first image portion of the first motion clip and a second image portion of a second motion clip of the selected second motion clips, calculates the first and second image portions using a dynamic time warping method to equalize the image portions thereof and record comparative relationships thereof, and merges the first image portion of the first motion clip with the second image portion of the second motion clip.

15. A computer-readable storage medium storing a computer program providing a motion transition method for dynamic images, comprising using a computer to perform the steps of:
pre-recording at least one motion transition data comprising plural image frames;
clustering the image frames to generate a graphic structure comprising plural motion clusters;
determining a motion cluster, residing in the graphic structure, that provides at least one second motion clip merging a first motion clip and a third motion clip;
performing a path search operation to determine whether at least one motion path corresponding to the second motion clip is located in the graphic structure;
if a motion path is located, respectively selecting at least one second motion clip from plural motion clusters along the motion path to retrieve plural second motion clips as motion transition data; and
adjusting the second motion clips and merging the first motion clip and the third motion clip using the second motion clips.

16. The computer-readable storage medium as claimed in claim 15, wherein the motion transition data is generated using a mathematical algorithm if the motion path is not located.

17. The computer-readable storage medium as claimed in claim 15, wherein the clustering step further comprises:
serving a first motion posture of a first image frame as a central motion posture of a first motion cluster;
determining the difference between a second motion posture of a second image frame and the central motion posture;
merging the second image frame into the first motion cluster if the difference is less than a predetermined threshold value; and
creating a second motion cluster if the difference is greater than that of the predetermined threshold value, and serving the second motion posture as a central motion posture of the second motion cluster.

18. The computer-readable storage medium as claimed in claim 17, wherein the clustering step further comprises determining the difference between the first and second motion posture according to a distance gap in the space between each joint nodes relating to the first and second motion posture.

19. The computer-readable storage medium as claimed in claim 17, further comprising:
generating at least one first motion clip cluster and at least one second motion clip cluster according to the similarity between the first and third motion posture, wherein each motion clip cluster comprises plural motion clips and each motion clip comprises plural image frames;
comparing the first motion posture of the first motion clip of the first motion clip cluster with the last motion posture of a synthesized motion clip to obtain differences between each of the motion postures; and
based on motion postures of which the differences correspond to a threshold value, selecting satisfied motion clip clusters with the length of a motion clip corresponding to a predefined threshold value to serve motion clips of the selected motion clip clusters as the motion transition data.

20. The computer-readable storage medium as claimed in claim 15, wherein the graphic structure at least comprises a first motion cluster and a second motion cluster, and the clustering step further comprises:
generating a motion path for the first motion cluster directing to the second motion cluster, when the first and second motion clips belongs to the same motion data.

21. The computer-readable storage medium as claimed in claim 15, wherein merging the first motion clip and the third motion clip further comprises:
respectively defining image lengths of a first image portion of the first motion clip and a second image portion of a second motion clip of the selected second motion clips;
calculating the first and second image portions using a dynamic time warping method to equalize the image portions thereof and record comparative relationships thereof; and
merging the first image portion of the first motion clip with the second image portion of the second motion clip.
